(19) United States
(12) Patent Application Publication
(10) Pub. No.: US 2023/0231245 A1
(43) Pub. Date: Jul. 20, 2023

(54) SYSTEM OF ENERGY ABSORPTION OF AN ELECTRIC AIRCRAFT IN A CRASH

(71) Applicant: BETA AIR, LLC, SOUTH BURLINGTON, VT (US)

(72) Inventor: Louis Gauthier, SOUTH BURLINGTON, VT (US)

(73) Assignee: BETA AIR, LLC, SOUTH BURLINGTON, VT (US)

(21) Appl. No.: 18/096,898

(22) Filed: Jan. 13, 2023

Related U.S. Application Data
(63) Continuation-in-part of application No. 17/878,009, filed on Jul. 31, 2022.
Application No. 17/878,009 is a continuation of application No. 17/319,174, filed on May 13, 2021, now Pat. No. 11,456,499.
Application No. 17/319,174 is a continuation-in-part of application No. 17/854,812, filed on Jun. 30, 2022.
Application No. 17/854,812 is a continuation of application No. 17/319,182, filed on May 13, 2021, now Pat. No. 11,394,092.

(51) Int. Cl. H01M 50/184; H01M 10/04; H01M 50/169

(52) U.S. Cl. CPC H01M 50/184; H01M 10/04; H01M 50/169

(57) ABSTRACT

Aspects related to a system of energy absorption of an electric aircraft in a crash is disclosed. The system may include a battery pack, wherein the battery pack may include a case, wherein the case is configured to circumscribe an inner volume of the battery pack. The battery pack may include a battery storage zone. The battery pack may include at least a battery module installed within the inner volume of the case. The system may include an energy absorbing material configured to absorb energy forced to the electric aircraft.

### CROSS-REFERENCE TO RELATED APPLICATIONS

This application is a continuation-in-part of U.S. patent application Ser. No. 17/878,009, filed on Jul. 31, 2022, entitled “SYSTEMS AND METHODS OF USE FOR A BATTERY PACK ENCLOSURE,” which is a continuation of Non-provisional application Ser. No. 17/319,174 filed on May 13, 2021 and entitled “SYSTEMS AND METHODS OF USE FOR A BATTERY PACK ENCLOSURE,” and a continuation-in-part of U.S. patent application Ser. No. 17/854,812, filed on Jun. 30, 2022, entitled “CRASH SAFE BATTERY PACK FOR MEDIATING RISKS OF THERMAL RUNAWAY DURING IMPACT,” which is a continuation of Non-provisional application Ser. No. 17/319,182 filed on May 13, 2021 and entitled “A CRASH SAFE BATTERY PACK FOR MEDIATING RISKS OF THERMAL RUNAWAY DURING IMPACT.” Each of U.S. patent application Ser. No. 17/878,009, U.S. patent application Ser. No. 17/319,174, U.S. patent application Ser. No. 17/857,812, and U.S. patent application Ser. No. 17/319,182 are incorporated by reference herein in its entirety.

### FIELD OF THE INVENTION

The present invention generally relates to the field of an aircraft. In particular, the present invention is directed to a system of energy absorption of an electric aircraft in a crash.

### BACKGROUND

An aircraft with battery packs often needs to tolerate forces that are resulted from a crash. The aircraft can hit land or water and damage the aircraft and the battery packs. Protecting the aircraft and the battery packs is crucial for occupant safety. Existing solutions to protect an aircraft and a battery pack from forces generated from a crash are not sufficient.

### SUMMARY OF THE DISCLOSURE

In an aspect, a system of energy absorption of an electric aircraft in a crash is disclosed. The system may include a battery pack, wherein the battery pack may include a case, wherein the case is configured to circumscribe an inner volume of the battery pack. The battery pack may include a battery storage zone. The battery pack may include at least a battery module installed within the inner volume of the case. The system may include an energy absorbing material configured to absorb energy forced to the electric aircraft. These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic illustration of an exemplary battery pack;

FIG. 2 is a schematic illustration of an unassembled exemplary battery pack;

FIG. 3 is a cross-sectional view of a schematic illustration of an exemplary battery enclosure;

FIGS. 4A-D are exemplary embodiments of energy absorbing materials with a battery module;

FIG. 5 is a schematic diagram of an exemplary frangible connection in an unbroken state;

FIG. 6 is a schematic diagram of an exemplary frangible connection in a broken state;

FIG. 7 is a schematic diagram of an exemplary crash safe battery pack undergoing an impact;

FIG. 8 is a schematic diagram of another exemplary crash safe battery pack; FIG. 9 is a schematic diagram of another exemplary crash safe battery pack undergoing an impact; and

FIG. 10 is a schematic illustration of a portion of an exemplary aircraft with exemplary energy absorbing materials.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a system of energy absorption of an electric aircraft in a crash is disclosed. The system may include a battery pack, wherein the battery pack may include a case, wherein the case is configured to circumscribe an inner volume of the battery pack. The battery pack may include a battery storage zone. The battery pack may include at least a battery module installed within the inner volume of the case. The system may include an energy absorbing material configured to absorb energy forced to the electric aircraft. Exemplary embodiments illustrating aspects of the present disclosure are described below in the context of several specific examples.

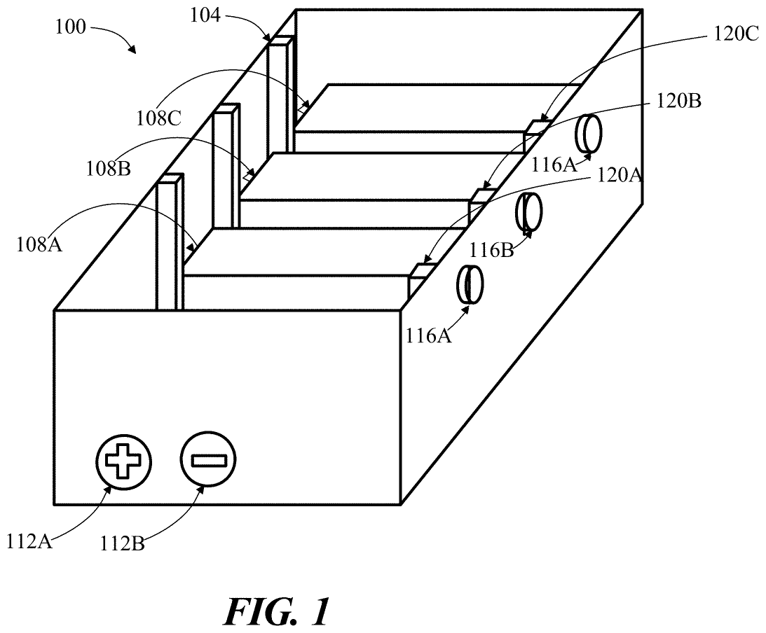

Referring now to the drawings, FIG. 1 illustrates an exemplary battery pack 100. According to some embodiments, a battery pack 100 includes an outer case 104. In some cases, case 104 may be made from metal for example one or more of sheet metal, stamped metal, extruded metal, and/or machined metal. In some cases, case 104 may be formed by way of welding, brazing, and/or soldering. In some cases, case 104 may be composed wholly or in part of a relatively light and strong metal, such as without limitation aluminum alloy. As shown in FIG. 1, case 104, may include an outer case, which may substantially enclose a plurality of battery modules 108A-C. In some versions, case may provide a firewall between flammable battery modules within battery pack and an environment or vehicle surrounding the battery pack.

Still referring to FIG. 1, in some embodiments, battery modules 108A-C may include any battery modules or battery cells described throughout this disclosure, for instance without limitation those described below. Typically, battery modules 108A-C are connected in series to one another, such that a total potential for all of the battery modules together is greater than a potential for any one of the battery modules (e.g., 108A). In some cases, a shared electrical connection from plurality of modules 108A-C may be accessible by way of an electrical connector 112A-B. In some cases, the electrical connector 112A-B may have a polarity and include a positive connection 112A and a negative connection 112B. In some cases, one or more battery modules of plurality of battery modules 108A-C may be mounted to case 104 by way of at least a breakaway mount 116A-C. In some embodiments, a breakaway mount may include any means for attachment that is configured to disconnect under a predetermined load. In some cases, breakaway mounts may be passive and rely upon loading forces for disconnection, such as exemplary breakaway mounts which may include one or more of a shear pin, a frangible nut, a frangible bolt, a breakaway nut, bolt, or stud, and the like. In some cases, a passive breakaway mount may include a relatively soft or brittle material (e.g., plastic) which is easily broken under achievable loads. Alternatively or additionally, a breakaway mount may include a notch, a score line, or another weakening feature purposefully introduced to the mount to introduce breaking at a prescribed load. According to some embodiments, a canted coil spring may be used to as part of a breakaway mount, to ensure that the mount disconnects under a predetermined loading condition. In some cases a mount may comprise a canted coil spring, a housing, and a piston; and sizes and profiles of the housing and the piston may be selected in order to prescribe a force required to disconnect the mount. An exemplary canted coil spring may be provided by Bal-Seal Engineering, Inc. of Foothill Ranch, Calif., U.S.A. Alternatively or additionally, a breakaway mount may include an active feature which is configured to actively disconnect a mount under a prescribed condition (for instance a rapid change in elevation or large measured G-forces). Much like an airbag that is configured to activate during a crash, an active mount may be configured to actively disconnect during a sensed crash. An active mount may, in some cases, include one or more of an explosive bolt, an explosive nut, an electro-magnetic connection, and the like. In some cases, one or more breakaway mounts 116A-C may be configured to disconnect under a certain loading condition, for instance a force in excess of a predetermined threshold (i.e., battery breakaway force) acting substantially along (e.g., within about)+/−45° a predetermined direction. Non-limiting exemplary battery breakaway forces may include decelerations in excess of 4, 12, 20, 50, or 100 G, 200 G, and the like.

Still referring to FIG. 1, in some embodiments, a case 104 circumscribes an inner volume, which may include a battery storage zone, for instance within which battery modules 108A-C are located, and a crush zone. As a non-limiting example, crush zone may be located between one or more battery modules 108A-C and an inner wall of case 104. In some embodiments, crush zone may be substantially empty. Alternatively, in some other embodiments, crush zone may comprise some material, such as without limitation a compressible material. In some cases, compressible material may be configured to absorb and/or dissipate energy as it is compressed. In some cases, compressible material may include a material having a number of voids; for instance, compressible material may take a form of a honeycomb or another predictably cellular form. Alternatively or additionally, compressible material may include a non-uniform material, such as without limitation a foam. In some embodiments, a crush zone may be located down from one or more battery modules 108A-C substantially along a loading direction, such that for instance the one or more battery modules when disconnected from one or more breakaway mounts 116A-C may be directed toward crush zone. In some cases, case 104 may include one or more channels or guides 120A-C configured to direct at least a battery module 108A-C into a crush zone, should it become disconnected from the case.

Still referring to FIG. 1, in some embodiments, battery module 108A-C may include Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon, tin nanocrystals, graphite, graphene or titanate anode, or the like. Batteries and/or battery modules may include without limitation batteries using nickel-based chemistries such as nickel cadmium or nickel metal hydride, batteries using lithium-ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), batteries using lithium polymer technology, metal-air batteries. Battery modules 108A-C may include lead-based batteries such as without limitation lead acid batteries and lead carbon batteries. Battery modules 108A-C may include lithium sulfur batteries, magnesium ion batteries, and/or sodium ion batteries. Batteries may include solid state batteries or supercapacitors or another suitable energy source. Batteries may be primary or secondary or a combination of both. Additional disclosure related to batteries and battery modules may be found in co-owned U.S. Patent Applications entitled “SYSTEM AND METHOD FOR HIGH ENERGY DENSITY BATTERY MODULE” and “SYSTEMS AND METHODS FOR RESTRICTING POWER TO A LOAD TO PREVENT ENGAGING CIRCUIT PROTECTION DEVICE FOR AN AIRCRAFT,” having U.S. patent application Ser. Nos. 16/948,140 and 16/590,496 respectively; the entirety of both applications are incorporated herein by reference. Persons skilled in the art, upon reviewing the entirety of this disclosure, will be aware of various devices of components that may be used as a battery module. In some cases, case 104 is constructed in a manner that maximizes manufacturing efficiencies.

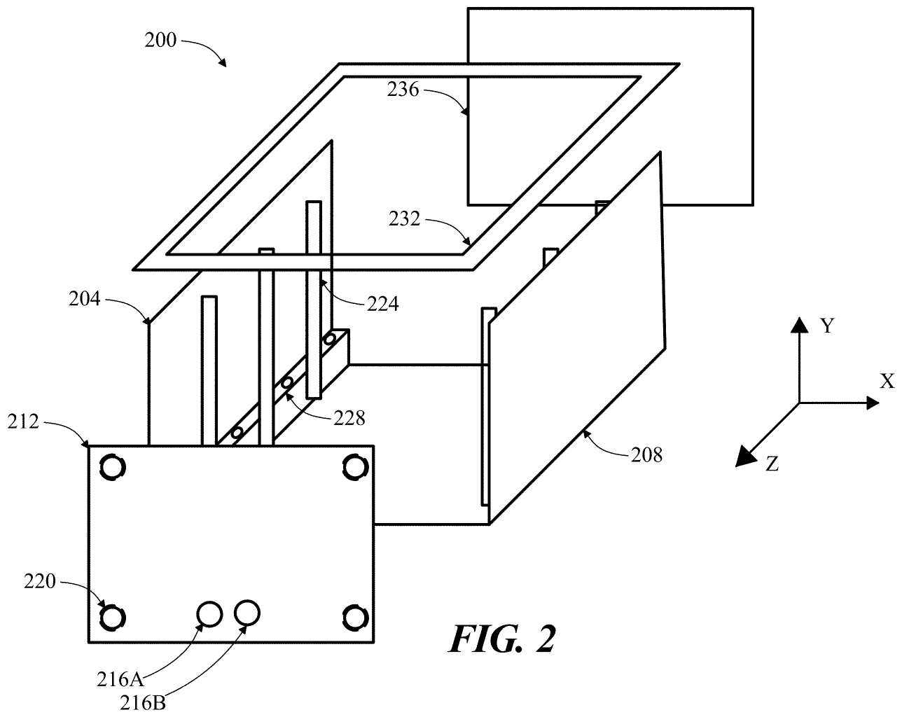

Referring now to FIG. 2, an exemplary unassembled case 200 is schematically shown. According to some embodiments, case may constitute a first component 204 that comprises two or more sides. In some embodiments, first component 204 may comprised formed sheet-metal. Formed sheet-metal may include, for instance without limitation a folded edge 208 or corner. Folded features, such as a folded edge 208, may differ from other metal features of the same shape in that folding process used to produce such folded features introduces yields and cold-works metal about such folded features. In some cases, first component 204 may include at least two separate sheet metal sub-components that may be joined together, for example along an edge 208. Joining methods are described throughout this disclosure and include without limitation soldering, brazing, welding, adhering, interference (i.e., engineering) fits, fastening, and the like. References to sheet-metal within this disclosure should not be understood as limited to sheet metal workpieces or items prepared according to any specific manufacturing method; any manufacturing method or process capable of producing a sheet metal part and/or workpiece is contemplated as within the scope of this disclosure. Sheet-metal may include any formation of metal in a sheet, for instance metal that has a thickness less than about 5 mm, or 3 mm and/or has a folded stamped or sheared feature. In some cases, first component 204 may constitute three sides of an unassembled box 200, as is shown in FIG. 2. For instance, first component 204 may be formed according to understood sheet metal processes into a shape, such as a U-channel. Alternatively or additionally, in some embodiments first component may include an extrusion. Extruded metal differs from sheet-metal in a number of ways. For instance, extruded metal may be of a different grade than sheet-metal; also, extruded metal may not typically have cold-worked metal about corner and edge features as sheet-metal often does. This is because extrusions may commonly be performed at elevated temperatures, which may effectively eliminate most dislocations within a crystalline structure of an extruded metal that may be associated with cold work and sheet-metal forming processes. In another non-limiting example first component 204 may include four sides of a case. In yet another non-limiting example first component 204 may comprise only 2 sides of a case, such as in an “L” shape.

Still referring to FIG. 2, a case may additionally include a second component 212. In some cases, second component 212 may include machined features, for instance without limitation threaded holes, blind holes, through holes, pockets, shoulders, and the like. Machined features, in some cases, differ in shape and profile from other types of metal described in this disclosure (e.g., sheet-metal). Additionally, machined metal may be heat treated and free from cold-work and dislocations common with formed sheet-metal. Additionally, machined metal features may be formed through removal of material by way of chip formation. This method of formation may yield shapes, profiles, and measurable surface finishes that are distinct when compared to other types of metal described in this disclosure (e.g., sheet-metal). For at least these reasons, reference to a machined metal or feature, should not necessitate a product-by-process interpretation. In some cases, second component 212 may include at least an electrical connection 216A-B. Electrical connection may comprise any of a high voltage connection 216A to at least a battery module or a low voltage connection 216B to at least a battery module. In some instances, a high voltage connection 216A to at least a battery module may be used to provide power from the at least a battery module; in some cases, the high voltage connection 216A may be configured to conduct electricity having a potential within a range of about 12 to 1,000V. Likewise, in some instances, a low voltage connection may be used to provide communications with at least a battery module or a corresponding battery controller; in some cases, the low voltage connection may be configured to conduct electricity having a potential within a range of about 0.1 to 24V. In some cases, second component 212 includes at least a mechanical connection 220, which allows mounting of battery pack, such as without limitation to an electrical aerial vehicle. Mechanical connection 220 may include a breakaway mount which may be configured to disconnect battery pack under a predetermined load, for instance during an impact of a force in excess of a threshold amount or maximum.

Still referring to FIG. 2, in some embodiments, a breakaway mount may include any means for attachment that is configured to disconnect under a predetermined load. In some cases, breakaway mounts may be passive and rely upon loading forces for disconnection; for instance exemplary breakaway mounts may include one or more of a shear pin, a frangible nut, a frangible bolt, a breakaway nut, bolt, or stud, or the like. In some cases, a passive breakaway mount may include a relatively soft or brittle material (e.g., plastic) which may be easily broken under achievable loads. Alternatively or additionally, a breakaway mount may include a notch, a perforation, a score line, and/or another weakening feature purposefully introduced to the breakaway mount to introduce breaking at a prescribed load. According to some embodiments, a canted coil spring may be used to as part of a breakaway mount, to ensure that the breakaway mount disconnects under a predetermined loading condition. In some cases a mount may comprise a canted coil spring, a housing, and a piston; and sizes and profiles of the housing and the piston may be selected in order to prescribe a force required to disconnect the mount. An exemplary canted coil spring may be provided by Bal-Seal Engineering, Inc. of Foothill Ranch, Calif., U.S.A. Alternatively or additionally, a breakaway mount may include an active feature which is configured to actively disconnect the breakaway mount under a prescribed condition, such as without limitation a rapid change in elevation, large measured force, large measured deceleration, or the like. Much like an airbag that is configured to activate during a crash, an active mount may be configured to actively disconnect during a sensed crash. An active mount may, in some cases, include one or more of an explosive bolt, an explosive nut, an electro-magnetic connection, and the like. In some cases, one or more breakaway mounts may be configured to disconnect under a certain loading condition, for instance a force in excess of a predetermined threshold (i.e., battery pack breakaway force) acting substantially along (e.g., within about)+/−45° a predetermined direction. Non-limiting exemplary battery pack breakaway forces may include decelerations in excess of about 4, 12, 20, 50, or 100 G's.

Still referring to FIG. 2, in some embodiments, case additionally may include at least a compression tube 224. At least a compression tube 224 may be installed within case to provide added rigidity and resistance to compressive forces substantially along a predetermined axis, for instance a vertical axis, shown as “Y” in FIG. 2. In some embodiments, compression tubes may include a metal that may be similar or non-similar to metal of first component 204 and/or second component 212. In some cases, compression tubes 224 may be non-metal; for instance, compression tubes may be ceramic. In some cases, compression tubes 224 may be welded into case; alternatively or additionally compression tubes may be mounted within case using any known attachment means, including without limitation interference (i.e., press) fit, clearance (i.e., slip) fit, fasteners, adhesives, and the like.

Still referring to FIG. 2, according to some embodiments, case may include a module support 228. Module support 228 may be configured to mount at least a battery module. In some cases, module support may be composed of machined metal, as described in this disclosure. Module support 228 may include one or more machined features, such as without limitation threaded holes, through holes, pockets, locating features, high tolerance features (e.g., no more than +/−0.01″), and the like. In some embodiments, module support may be mounted to case (e.g., first component and/or second component) by way of one or attachment means including without limitation welding, soldering brazing, adhesive, fasteners, and the like.

Still referring to FIG. 2, according to some embodiments, case additionally includes a sealing rim 232. In some cases, sealing rim 232 substantially surrounds an open face of case; in some versions, the sealing rim 232 substantially surrounds the only open face of the case and the rest of the case remains sealed. In some embodiments, sealing rim 232 may comprise a metal that is similar or non-similar to metal of first component 204 and/or second component 212. In some cases, sealing rim 232 may be non-metal; for instance, sealing rim 232 may be ceramic. In some cases, sealing rim may comprise machined metal, as described in this disclosure. Sealing rim 232 may include one or more machined features, such as without limitation threaded holes, through holes, pockets, locating features, high tolerance features (e.g., no more than +/−0.01″), and the like. In some cases, sealing rim 232 may be welded into case, alternatively or additionally sealing rim 232 may be mounted onto case using any known attachment means, including without limitation interference (i.e., press) fit, clearance (i.e., slip) fit, fasteners, adhesives, and the like. In some cases, sealing rim may be mounted only to first component 204. In some cases, sealing rim 232 may be configured to interface and mount to a cover. A seal between cover and sealing rim 232 may be provided for by a gasket or any other sealing mechanism, such as without limitation seals, O-rings, interference press fits, lip seals, and the like.

Still referring to FIG. 2, according to some embodiments, a third component 236 may be included in case. Third component may, as is shown in FIG. 2, be located opposite second component 212; additionally, third component 236 may include some or all of characteristics, configurations, and features of the second component 212. Accordingly, in some cases, third component 236 may comprises machined features, for instance without limitation threaded holes, blind holes, through holes, pockets, shoulders, and the like. Machined features, in some cases, differ in shape and profile from other types of metal described in this disclosure (e.g., sheet-metal). Additionally, machined metal may be heat treated and free from cold-work and dislocations common with formed sheet-metal. Machined metal therefore may have a homogenous temper throughout, unlike for instance sheet-metal. Additionally, machined metal features may be formed through removal of material by way of chip formation. This method of formation may yield shapes, profiles, and measurable surface finishes that are distinct when compared to other types of metal described in this disclosure (e.g., sheet-metal). For instance machined metal components may achieve tolerances in a range of about 0.0005″ to about 0.01,″ Whereas sheet-metal tolerances may seldom be less than about 0.005″. Additionally, surface finish for a machined part may commonly have an average surface roughness (Rₐ) from between about 10 to about 250 μin, whereas sheet-metal surface finish may run a gambit from a mirror polish to a “mill” cold rolled finish, with brushed surfaces finished in between, although commonly, sheet-metal may exhibit a rougher surface finish than a machined component. For at least these reasons, reference to a machined metal or feature, should not necessitate a product-by-process interpretation. In some cases, third component 236 may include at least an electrical connection. In some cases, third component 236 may include at least a mechanical connection, which may allow mounting of battery pack, for instance without limitation to an electrical aerial vehicle.

Still referring to FIG. 2, in some embodiments, some or all components may be attached by way of one or more of welding, brazing, and/or soldering. For instance, in some situations, first component 204 and second component 212 may be welded together, such that both components are sealed at a weld joint. In some versions, substantially all of case is welded together, so that an inner volume of case may be continuously sealed on at least 5 sides by the case.

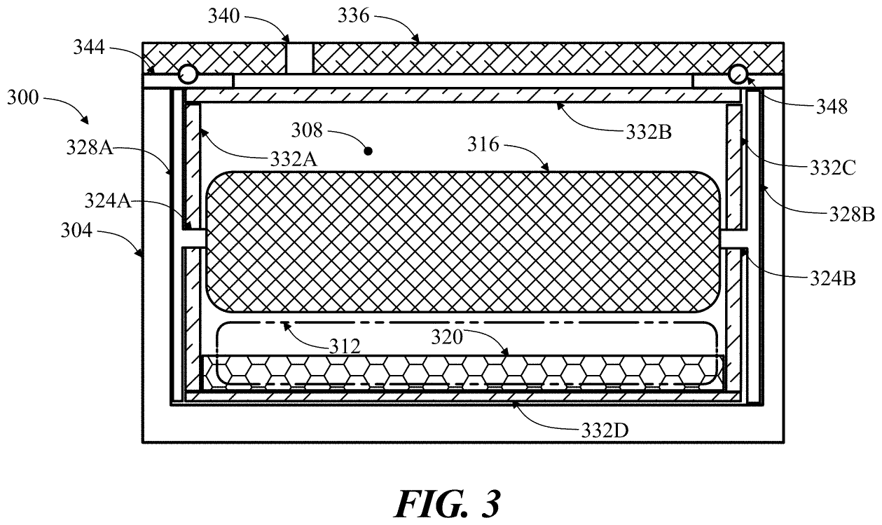

Referring now to FIG. 3, a cross-sectional view of an exemplary enclosure 300 for a battery pack is schematically illustrated. A case 304 is shown encompassing an inner volume 308. In some versions, inner volume may include at least a crush zone 312. Crush zone 312 may include a volume within inner volume 308 inside which substantially no battery modules may typically be present. Crush zones may be purposefully configured to crumple, deform, or otherwise change shape or contents during a crash or impact. Typically, crush zone 312 may be located between one or more battery modules 316 and an inner wall of case 304. In some embodiments, crush zone may be substantially empty. Alternatively, in some other embodiments, crush zone 316 may comprise some material, such as without limitation energy absorbing material 320 Energy absorbing material 320 disclosed herein is further described below. In some embodiments, a crush zone 316 may be located down from one or more battery modules 308 substantially along a loading direction, such that for instance the one or more battery modules when disconnected from one or more mounts 324A-B are directed toward crush zone 316. In some versions, one or more mounts 324A-B may comprise a breakaway mount, as described in this disclosure. In some cases, case 304 may include one or more channels or guides that may be configured to direct at least a battery module 316 into a crush zone 312, should the battery module become disconnected from the case.

Still referring to FIG. 3, in some embodiments, enclosure 300 may include energy absorbing material 320. As used in this disclosure, an “energy absorbing material” is a material that absorbs energy forced to an object and/or device that the energy absorbing material is placed on. As a non-limiting example, the object and/or device may include an electric aircraft, a battery pack, a battery module, and the like. In some cases, energy absorbing material 320 may be configured to absorb and/or dissipate energy as it is compressed. In some embodiments, energy absorbing material 320 may be completely crushable. In some cases, energy absorbing material 320 may include a material having a number of voids, for instance energy absorbing material 320 may take a form of a honeycomb, sinusoid, semi-circle or another predictably cellular form. In some embodiments, energy absorbing material 320 may include fiber composites, foams, gels, magneto-rheological (MR) fluids, metals, porous materials, and the like. In some embodiments, energy absorbing material 320 may include a shear pin. As used in this disclosure, a “shear pin” is a mechanical device that is designed to shear in case of intensive force is applied to it and protect other parts. Alternatively, or additionally, energy absorbing material 320 may include a non-uniform material, such as without limitation a foam. In some embodiments, energy absorbing material may take a form of a panel. As used in this disclosure, a “panel” is a shape of a component that is typically long and flat along a surface. In some embodiments, energy absorbing material may take a form of a block. As used in this disclosure, a “block” is a shape of a component that is typically a shape of square or rectangle.

Still referring to FIG. 3, in some embodiments, enclosure 300 may include a plurality of energy absorbing material 320. In an embodiment, enclosure 300 may include same the plurality of energy absorbing material 320. As a non-limiting example, enclosure 300 may include a plurality of honeycomb sandwich panels. As used in this disclosure, a “honeycomb sandwich panel” is a panel with an inner structure of honeycomb sandwiched between thin composite laminates. In some embodiments, the honeycomb structure may include Nomex, fiberglass, aluminum, and/or the like. In another embodiment, enclosure 300 may include different types of the plurality of energy absorbing material 320. As a non-limiting example, enclosure 300 may include a honeycomb sandwich panel and a polymethacrylimide (PMI) foam. As used in this disclosure, “polymethacrylimide foam” is a type of foam made with polymethacrylimide. As a non-limiting example, PMI foam may include Rohacell 51, Rohacell 71, Rohacell 110, and the like.

Still referring to FIG. 3, in an embodiment, energy absorbing material 320 may be placed underneath a battery pack. In another embodiment, energy absorbing material 320 may be placed underneath a battery module 316, wherein the battery module 316 is in the inner volume of the battery pack. In some embodiments, energy absorbing material 320 may surround a battery module. In some embodiments, energy absorbing material 320 may surround a battery pack. In some embodiments, energy absorbing material 320 may be underneath a battery mount 324A-B.

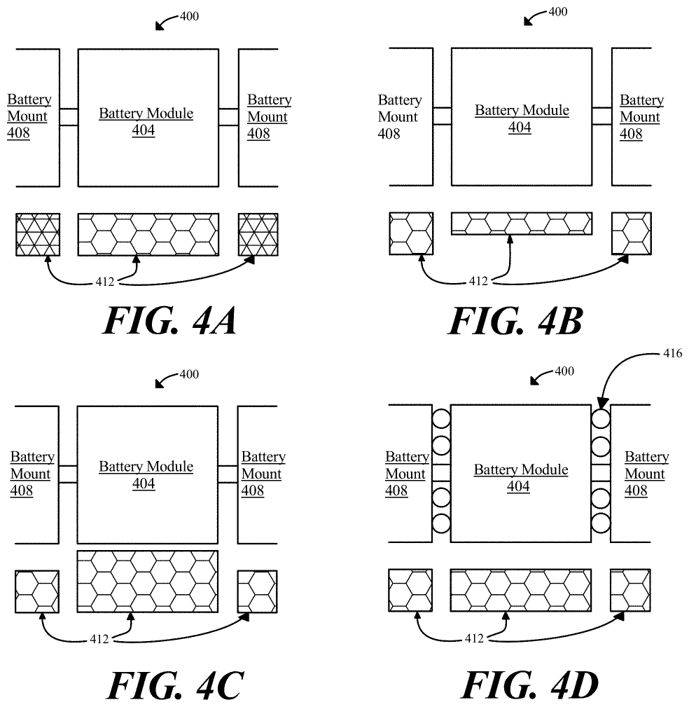

Additionally without limitation, energy absorbing material 320 may be on any side of a battery module 316. Additionally, without limitation, energy absorbing material 320 may be on any side of a battery pack. Additionally, without limitation, energy absorbing material 320 may be placed under and/or on any part of the battery pack. In an embodiment, there may be an empty space between energy absorbing material 320 and a part of the battery pack. As a non-limiting example, there may be at least a part of crush zone 312 between energy absorbing material 320 and battery module 316 as shown in FIG. 3. Additionally, energy absorbing material 320 may be consistent with energy absorbing material disclosed with respect to FIG. 4.

Still referring to FIG. 3, in some embodiments, the plurality of energy absorbing materials 320 may include a frame crash panel. As used in this disclosure, a “frame crash panel” is an energy absorbing material used for an aircraft. In an embodiment, the frame crash panel may be located at the bottom of a fuselage of an aircraft. As used in this disclosure a “fuselage” is the main body of an aircraft, or in other words, the entirety of the aircraft except for the cockpit, nose, wings, empennage, nacelles, any and all control surfaces, and generally contains an aircraft's payload. In some embodiments, the plurality of energy absorbing materials 320 may include a battery craft panel. As used in this disclosure, a “battery crash panel” is an energy absorbing material used for a battery pack of an aircraft. In some embodiments, the battery crash panel may be located beneath a plurality of battery packs. In some embodiments, the battery crash panel may be configured to receive a second impact of a crash of an aircraft, while the frame crash panel receives a first impact of the crash of the aircraft. The craft disclosed herein is further described below.

Still referring to FIG. 3, in some embodiments, energy absorbing material 320 may be configured to provide a deformable floor structure in a crash of an electric aircraft. As used in this disclosure, a “crash” is a collision of an aircraft onto hard surface. As a non-limiting example, hard surface may include ground, a building, aluminum, steel, and the like. In an embodiment, energy absorbing material 320 may be configured to tolerate 50 ft battery drop test. As used in this disclosure, “50 ft battery drop test” is a type of test to test the quality of battery pack by dropping battery pack from 50 ft onto hard structure. The 50 ft battery drop test may be performed by dropping a portion of aircraft containing battery pack, aircraft floor structure, keel beams and the like. In another embodiment, energy absorbing material 320 may tolerate 26 ft/sec aircraft drop test. As used in this disclosure, a “26 ft/sec aircraft drop test” is a type of test to test the quality of an aircraft by dropping the aircraft by 26 ft/sec deceleration. As used in this disclosure, “deceleration” is reduction in speed or rate. In some embodiments, energy absorbing material 320 may be configured to protect a battery pack from thermal runaway debris. As used in this disclosure, “thermal runaway debris” is any material that gets ejected from a battery cell of a battery pack during thermal runaway of the battery cell.

Still referring to FIG. 3, in some embodiments, enclosure 300 may include at least an inner panel 328A-B. Inner panel may be located between an inner wall of case 304 and at least a battery module 316. In some cases, at least an inner panel 328A-B may be a composite material, for instance to reduce weight of enclosure 300. A composite material may include a reinforced plastic (e.g., fiberglass, carbon fiber, and the like). In some cases, one or more mounts 324A-B may be affixed to at least an inner panel 328A-B. In some embodiments, at least an inner panel 328A-B may be configured to position at least a battery module 316. Additionally or alternatively, in some embodiments, at least an inner panel 328A-B may be configured to provide structural support and/or load transfer to enclosure. In some cases, at least an inner panel 328A-B may include an electrically insulating material and may be configured to provide electrical insulation between a battery module and electrically conductive components.

Still referring to FIG. 3, in some embodiments, enclosure may include at least a lining 332A-D. Lining 332A-D may be located between an inner wall of case 304 and at least a battery module 316. In some cases, at least a lining 332A-D may include an electrically insulating material, such as without limitation a polymer, a foam, a ceramic, and the like. In some versions, lining 332A-D may be configured to limit prevalence of situations that may result in short circuiting between electrically conductive components (such as case 304) and at least a battery module 316 or one or more electrical connections within battery pack.

Still referring to FIG. 3, in some embodiments, enclosure 300 may include a cover 336. Cover 336 may comprise metal (e.g., sheet-metal, machined metal, and the like). In some cases, cover may include at least a vent 340. Alternatively or additionally, in some cases, at least one of first component 204, second component 212, third component 236, and/or case 304 comprise vent 340. Vent 340 may be configured to allow for flow of fluids (e.g., air) between an inner volume 308 within enclosure 300 to outside the enclosure, such as without limitation an environment surrounding the enclosure. Vent 340, in some embodiments, may be configured to allow for controlled flow of fluids, such as without limitation with one or more of a valve, a regulator, and/or a filter. In some embodiments vent 340 may be in fluidic communication with one or more channels configured to further route a flow of fluids. In some embodiments, cover 336 may be mounted to enclosure 300 by way of a sealing rim 344. Sealing rim 344 may be attached to case 304 by way of any attachment method described within this disclosure. In some versions, a gasket 348 may be positioned between cover 340 and sealing rim 348 to enclosure 300, thereby preventing fluid ingress/egress from/to inner volume 308 not through vent 340.

Now referring to FIG. 4A-D, exemplary embodiments of battery pack 400 with a plurality of energy absorbing materials 412 and battery module 404 are illustrated. Battery module 404 may be consistent with any battery module disclosed in this disclosure. The plurality of energy absorbing materials 412 may be consistent with any energy absorbing materials disclosed in this disclosure. In some embodiments, battery pack 400 may include a plurality of energy absorbing materials. As a non-limiting example, the plurality of energy absorbing materials 412 may be placed underneath battery module 404 and battery mounts 408. Battery mounts 408 disclosed herein may be consistent with any battery mount disclosed in entire of this disclosure. As another non-limiting example, at least a slider 416 may be placed in between battery module 404 and battery mounts 408 as shown in FIG. 4D. As used in this disclosure, a “slider” is a type of energy absorbing material that absorbs energy by sliding an object attached to the slider in one direction when energy is applied to the object. As a non-limiting example, the at least a slider may absorb energy forced to battery module 404 by sliding battery module 404 in opposite direction of the force. As a non-limiting example, in the event of a crash, slide 416 may dissipate energy by allowing battery module 404 to slide in a downwards direction.

Still referring to FIG. 4A-D, in some embodiments, a plurality of energy absorbing materials 412 may include different types of energy absorbing materials 412. As shown in FIG. 4A, without limitation, an energy absorbing material of the plurality of energy absorbing materials 412 placed underneath battery module 404 may include a honeycomb sandwich panel, whereas an energy absorbing material of the plurality of energy absorbing materials 412 placed underneath battery mounts 408 include a foam, such as a PMI foam. As another non-limiting example, an energy absorbing material of the plurality of energy absorbing materials 412 placed underneath battery module 404 may include PMI foam when an energy absorbing material of the plurality of energy absorbing materials 412 placed underneath battery mounts 408 may include a shear pin.

Still referring to FIG. 4A-D, in some embodiments, a plurality of energy absorbing materials 412 may include different thickness to each of the plurality of energy absorbing materials 412. As shown in FIG. 4B, without limitation, an energy absorbing material of the plurality of energy absorbing materials 412 placed underneath battery module 404 may be thinner than an energy absorbing material of the plurality of energy absorbing materials 412 placed underneath battery mounts 408. As shown in FIG. 4C, without limitation, an energy absorbing material of the plurality of energy absorbing materials 412 placed underneath battery module 404 may be thicker than an energy absorbing material of the plurality of energy absorbing materials 412 placed underneath battery mounts 408.

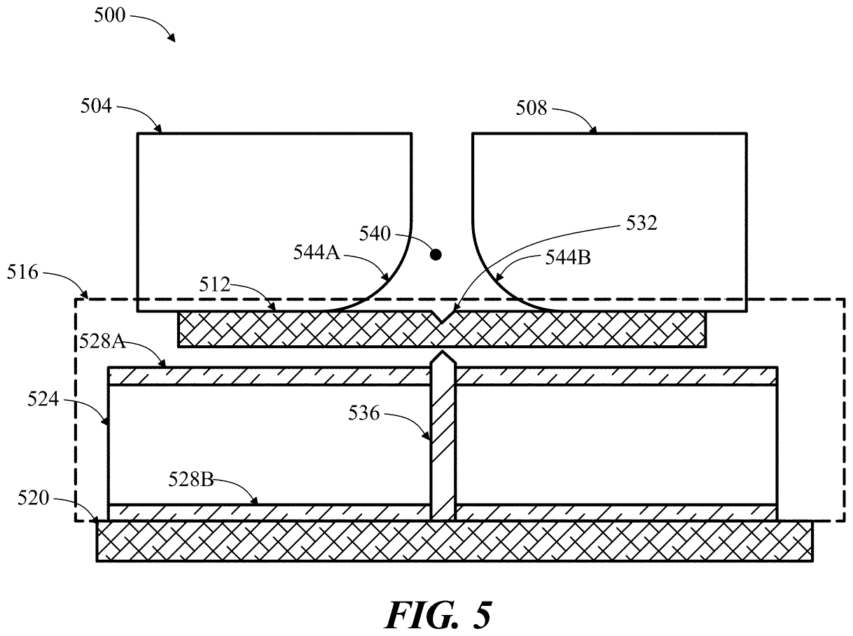

Referring now to FIG. 5, an exemplary frangible connection mechanism 500 is schematically shown. As used in this disclosure “frangible” is an attributive which refers to a components tendency to break apart (i.e., disintegrate or shatter) or yield on impact or under predetermined loading. In some embodiments, a frangible material may break apart or yield on impact in order to limit potential hazards (i.e., to fail safe). A first battery module 504 is shown in electrical connection with a second battery module 508, where electrical connection is provided by way of a frangible connection 512 (i.e., frangible bus). In some cases, frangible connection 512 may comprise one or more material attributes that include brittle, soft, and fragile. For instance in some non-limiting examples frangible connection may comprise a material having a yield strength no greater than 10 MPa, no greater than 5 Mpa, or no greater than 1 MPa. In some cases, frangible connection may comprise at least one of aluminum, copper, gold, nickel, and/or silver. In some cases, frangible connection 512 may be located substantially within crush zone 516. As described above, crush zone 516 may be located between one or more battery modules and an inner wall of a case 520. Crush zone 516 in some embodiments may be configured to allow room for one or more battery modules to decelerate and lose kinetic energy during an impact, for instance before coming into a collision with case 520 or another large object, such as ground. According to some embodiments, a compressible material 524 may be located between one or more battery modules and case 520. As described above, compressible material 524 may include any material which may absorb and/or dissipate energy as it is compressed. In some cases, compressible material 524 may comprise one or more of a composite material with voids, and/or a compressible fluid, such as without limitation air or nitrogen. In some cases, compressible material may include an incompressible fluid such as without limitation oil and/or grease. In some cases, compressible material includes foam or a cellular matrix. In some embodiments, compressible material 524 may be flanked on one or more sides by a composite sheet 528A-B. Composite sheet 528A-B in some cases, may be non-conductive and serve to prevent short circuiting of one or more battery modules. For instance composite sheet 528A-B, in some embodiments, may comprise one or more polymers, such as without limitation polytetrafluoroethylene (PTFE), polyethylene (PE), and the like.

Still referring to FIG. 5, in some embodiments, frangible connection 512 may include a score 532. Score 532 may include any feature intended to structurally weaken frangible connection 512, such as without limitation a notch, a groove, a perforation, a composite bridge (e.g., a soldered connection), and the like. In some cases, a weakening of frangible connection 512 may be configured to contribute to a breaking and disconnection of the frangible connection 512, for instance during an impact or under a predetermined loading condition (i.e., a connection breaking force). Non-limiting exemplary connection breaking force include between about may include forces resulting from decelerations, including impulsive impact derived decelerations, in excess of 4, 12, 50, 50, or 100 G's. In some embodiments, at least a breakaway mount may be configured to release first battery module under a battery breakaway force that is no greater than a connection breaking force.

Still referring to FIG. 5, in some instances a die 536 may be placed near a frangible connection 512, for instance without limitation opposite a score 532. As used in this disclosure, a “die” is a component that is intended to impart deformation forces to another component, such as without limitation a frangible connection. In some cases, a die 536 may be configured to introduce a pressure or an approximated point or line force at a predetermined location along frangible connection 512, for instance between a first battery module 504 and a second battery module 508. In some cases, die may comprise an electrically insulating material, for instance without limitation one or more of a ceramic, a plastic, a coated or composite metal component, a glass, and the like. In some cases, die 536 may be wholly composed of a non-conductive material. Alternatively, in some cases, die 536 may only partially be composed of a non-conductive material; for example, the die may include an aluminum substrate coated with a non-conductive coating, for instance alumina. In some cases, die 536 may be shaped like a wedge with an edge of the wedge directed to contact at or near a score 532 within frangible connection 512. In some embodiments a relief 540 may be located near frangible connection 512. As used in this disclosure, a “relief” is an area or volume that is substantially free from material and thereby provides space for other components or portions of components to occupy, such as without limitation a deformed frangible connection. Relief 540 may allow room for deformation of frangible connection 512, for example during a crash. Relief 540 may be located proximal to a side of frangible connection that is opposite die. In some cases, at least a profile 544A-B may aid in controlled breaking of frangible connection 512. For instance, in a non-limiting example, at least a profile 544A-B may include one or more of a radii or a chamfer configured to impart a load (e.g., bending moment, shear force, and the like) upon frangible connection 512 in certain circumstances. In some embodiments, die 536 may be configured not only to break or disconnect frangible connection 512, but may also be configured to separate two or more resulting portions of frangible connection from one another once separated.

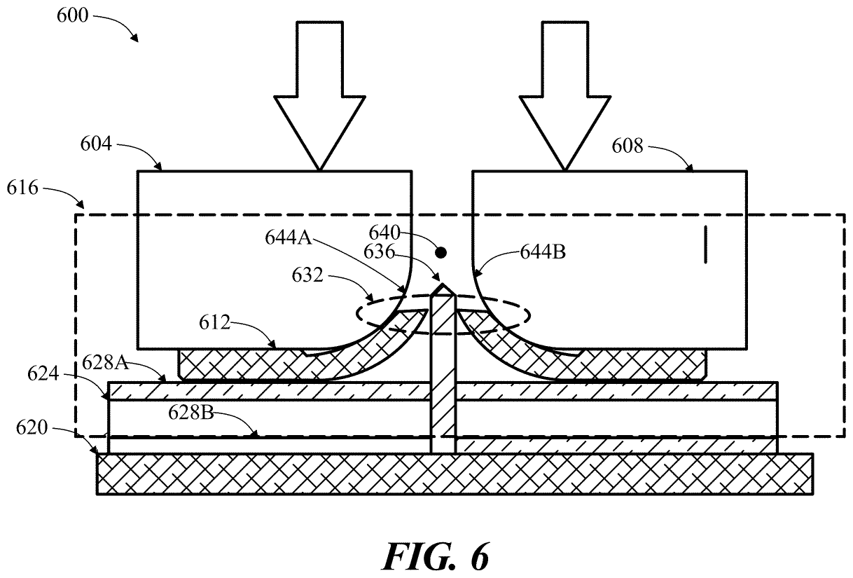

Referring now to FIG. 6, an exemplary frangible connection mechanism 600 is schematically shown after frangible connection has been broken and disconnected. A first battery module 604 is shown in electrical isolation with a second battery module 608, where electrical isolation is provided by way of a frangible connection 612 (i.e., frangible bus). FIG. 6 shows both first battery module 604 and second battery module 608 have encroached a crush zone 616 located between the first battery module 604, the second battery module 608 and an inner wall of a case 620. According to some embodiments, a compressible material 624 may be located between one or more battery modules and case 620. As a result of battery modules entering crush zone, compressible material 624 may compress, thereby absorbing and/or dissipating energy as it is compressed. In some embodiments, compressible material 624 may be flanked on one or more sides by a composite sheet 628A-B. Composite sheet 628A-B, in some cases, may be non-conductive and serve to prevent short circuiting of one or more battery modules.

Still referring to FIG. 6, in some embodiments, frangible connection 612 in a broken state may include a discontinuity 632. A discontinuity 632 may occur along any point on frangible connection 612, between first battery module 604 and second battery module 608. In some cases, discontinuity 636 may occur where a score or another weakening feature is present on an intact frangible connection. In some cases, a weakening of frangible connection may be configured to contribute to a forming of a discontinuity 632 and disconnection of the frangible connection 612, for instance during an impact or under a predetermined loading condition. In some instances a die 636 may be placed to aid in forming discontinuity 632. For instance, a die 636 placed near a frangible connection 612, may under predetermined conditions impart one or more of a pressure, an approximated point force, and/or an approximated line force, thereby forming a discontinuity 632. As described above, in some cases, die 636 may comprise an electrically insulating material, so that after forming discontinuity 632 within frangible connection 612, resulting two or more constituents of the frangible connection 612 remain electrically isolated from one another by the die 636. In some cases, die 636 may be shaped like a wedge with an edge of the wedge directed to contact at or near a score 632 within frangible connection 612. In some embodiments a relief 640 may be located near frangible connection 612. Relief 640 may allow room for deformation of frangible connection 612, for example during a crash. In some cases, at least a profile 644A-B may aid in controlled breaking of frangible connection 512. For instance, in a non-limiting example, at least a profile 644A-B may include one or more of a radii or a chamfer configured to impart a load (e.g., bending moment, shear force, and the like) upon frangible connection 612 in certain circumstances. According to some embodiments, battery pack may be configured to fail safe when impact occurs in a predetermine direction.

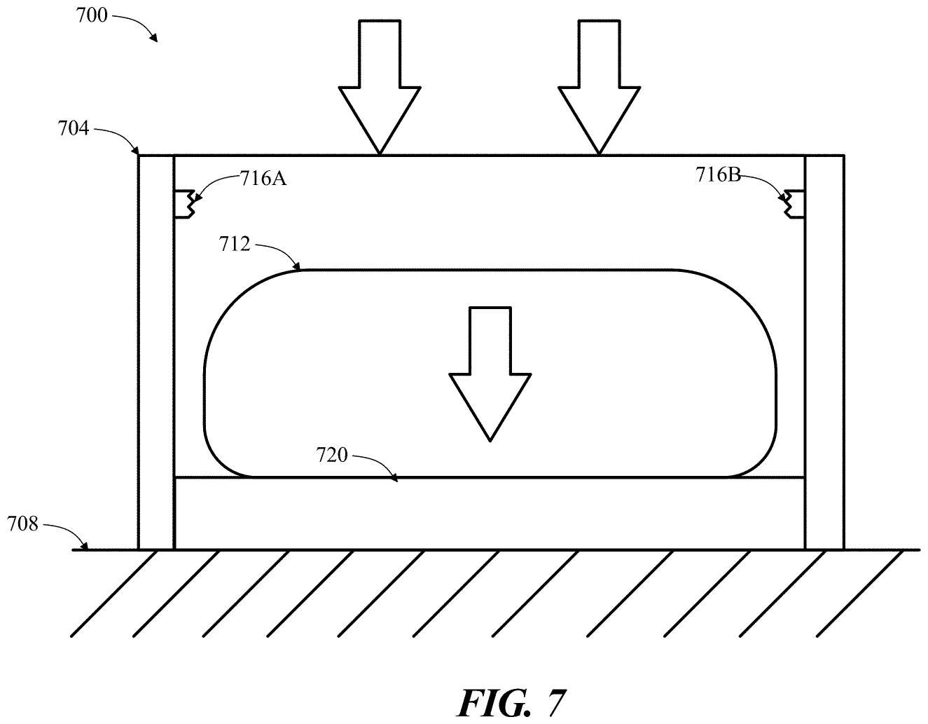

Referring now to FIG. 7, a schematic of an exemplary impact 700 is shown. In some cases, a battery pack 704 may predictably crash or impact an object 708, for instance ground, in a predictable manner. For example, in some cases, battery pack may be used on a vertical take-off and landing aircraft and may impact between aircraft and ground may occur predictably substantially along a vertical axis. In some cases battery pack may additionally include one more breakaway mounts for attaching battery pack to a vehicle, such that during an impact of sufficient force the battery pack 704 itself is detached from the vehicle. Alternatively or additionally, in some cases battery pack 704 may include at least a battery module 712 that is attached to the battery pack 704 by one or more breakaway mounts 716A-B. In some cases, breakaway mounts 716A-B may be configured to disconnect when an impact of a sufficient force occurs substantially in a predetermined direction, for instance as shown in FIG. 7. When battery module 712 becomes dislodged from battery pack 704 it may travel toward an ultimately into a crush zone 720. As described above, crush zone may include a compressible material and/or a frangible connection.

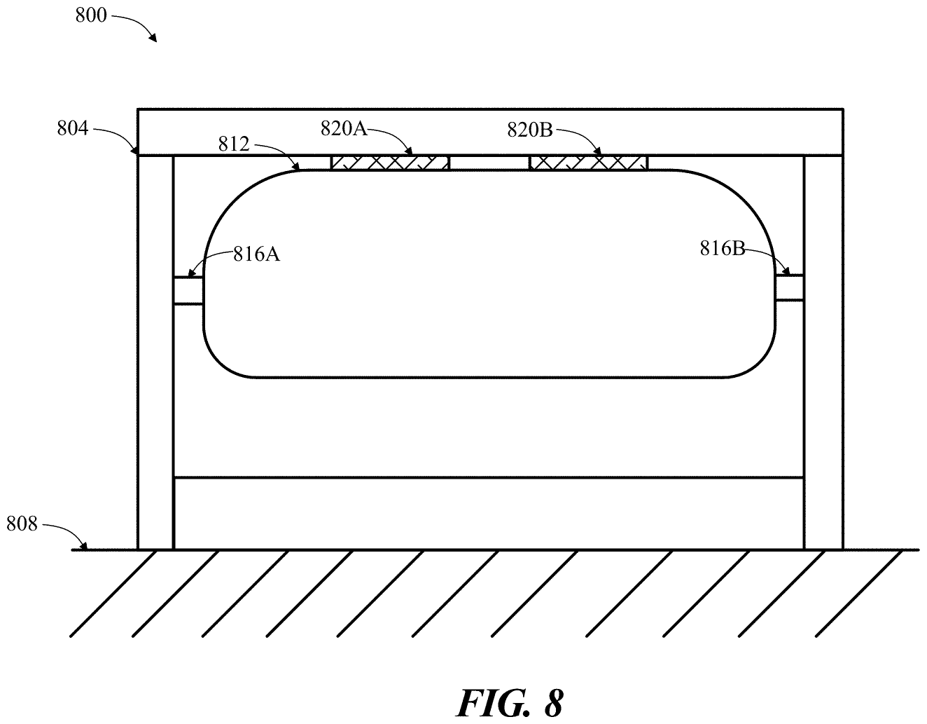

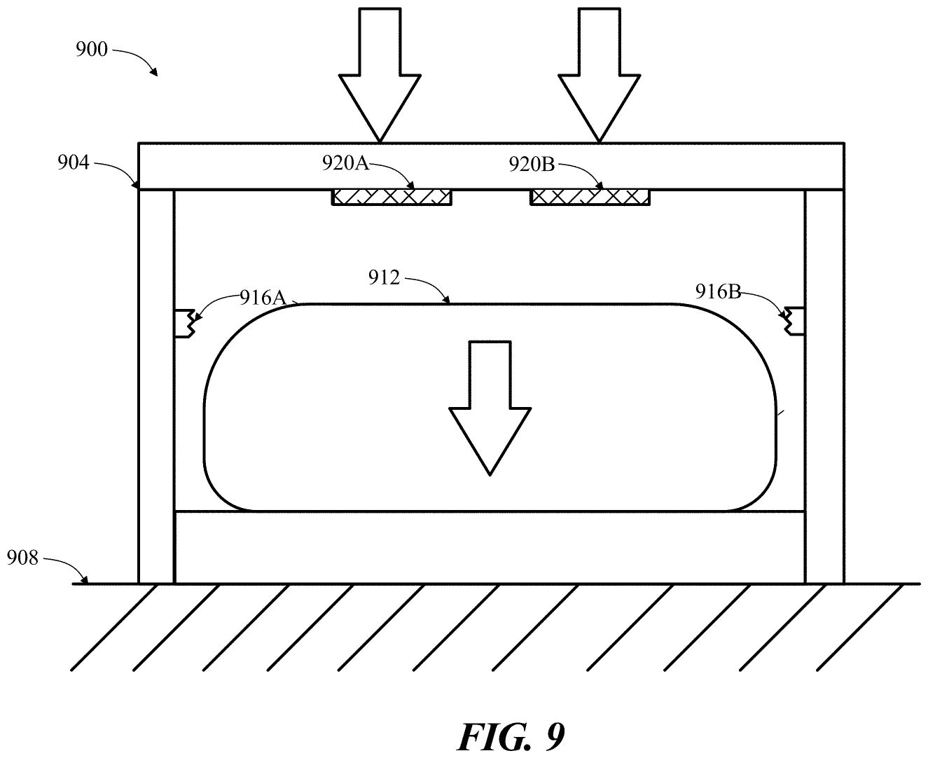

Referring now to FIG. 8, a schematic of another exemplary system 800 is shown. In some cases, a battery pack 804 may predictably crash or impact an object 808, for instance ground, in a predictable manner. For example, in some cases, battery pack 804 may be used on a vertical take-off and landing aircraft and may impact between aircraft and ground 808 may occur predictably substantially along a vertical axis. In some cases battery pack 804 may additionally include one more breakaway mounts for attaching battery pack to a vehicle, such that during an impact of sufficient force the battery pack 804 itself is detached from the vehicle. Alternatively or additionally, in some cases battery pack 804 may include at least a battery module 812 that is attached to the battery pack 804 by one or more breakaway mounts 816A-B. In some cases, breakaway mounts 816A-B may be configured to disconnect when an impact of a sufficient force occurs substantially in a predetermined direction, for instance as shown in FIG. 8. In some cases, a frangible connection may be disposed substantially outside of a crush zone. For example, as shown in FIG. 8, at least a frangible connection 820A-B may be located opposite a direction battery module 812 may travel in a crash causing breakaway mounts 816A-B to release. When battery module 812 becomes dislodged from battery pack 804 it may travel toward away from at least a frangible connection 820A-B, causing an electrical disconnection between the battery module 812 and the at least a frangible connection 820A-B.

Referring now to FIG. 9, a schematic of an exemplary impact 900 involving an exemplary system of FIG. 8 is shown. In some cases, a battery pack 904 may predictably crash or impact an object 908, for instance ground, in a predictable manner. For example, in some cases, battery pack 904 may be used on a vertical take-off and landing aircraft and may impact between aircraft and ground may occur predictably substantially along a vertical axis. In some cases battery pack may additionally include one more breakaway mounts for attaching battery pack to a vehicle, such that during an impact of sufficient force the battery pack 904 itself is detached from the vehicle. Alternatively or additionally, in some cases battery pack 904 may include at least a battery module 912 that is attached to the battery pack 904 by one or more breakaway mounts 916A-B. In some cases, breakaway mounts 916A-B may be configured to disconnect when an impact of a sufficient force occurs substantially in a predetermined direction, for instance as shown in FIG. 9. When battery module 912 becomes dislodged from battery pack 904 it may travel away from at least a frangible connection 920A-B, thereby breaking an electrical connection between the at least a frangible connection 920A-B and the battery module 912. In some cases, at least a frangible connection 920A-B may additionally include one or more breakaway mounts 916A-B.

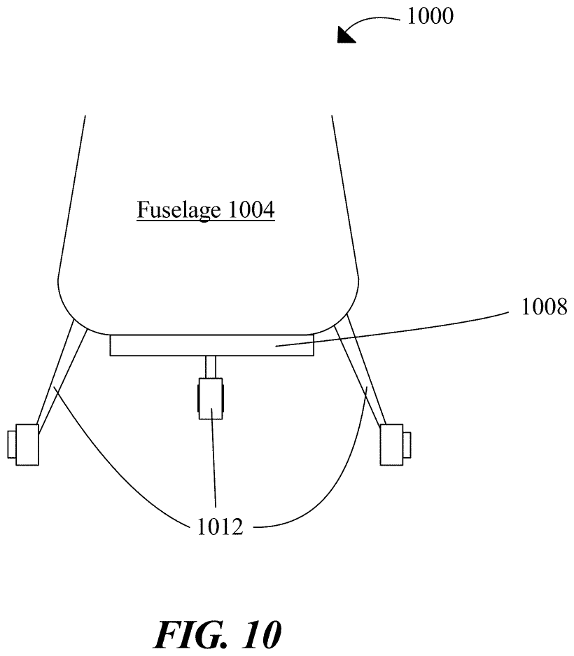

Referring now to FIG. 10, a schematic illustration of a portion of an exemplary aircraft 1000 with exemplary energy absorbing materials is shown. As used in this disclosure, “aircraft” is a type of vehicle that can fly. As a non-limiting example, aircraft may include airplanes, helicopters, airships, blimps, gliders, paramotors, and the like thereof. In some embodiments, aircraft 1000 may include an electric aircraft. As used in this disclosure, an “electric aircraft” is an aircraft that is electrically powered. Electric aircraft may be capable of rotor-based cruising flight, rotor-based takeoff, rotor-based landing, fixed-wing cruising flight, airplane-style takeoff, airplane-style landing, and/or any combination thereof. “Rotor-based flight,” as described in this disclosure, is where the aircraft generates lift and propulsion by way of one or more powered rotors coupled with an engine, such as a quadcopter, multi-rotor helicopter, or other vehicle that maintains its lift primarily using downward thrusting propulsors. “Fixed-wing flight,” as described in this disclosure, is where the aircraft is capable of flight using wings and/or foils that generate lift caused by the aircraft's forward airspeed and the shape of the wings and/or foils, such as airplane-style flight.

With continued reference to FIG. 10, in some embodiments, electric aircraft may be an electric vertical takeoff and landing (eVTOL) aircraft. An “eVTOL,” for the purposes of this disclosure, is an electric aircraft that can hover, take off, and land vertically. The eVTOL aircraft may include a flight transition point. The flight transition point, as used in this disclosure, is a point where an eVTOL aircraft changes its flight mode from vertical flight to forward flight. Vertical flight mode, as used in this disclosure, refers to a mode of an aircraft to propel an aircraft in a vertical direction, such as but not limited to vertical takeoff, vertical landing, and the like. Vertical propulsor may be used to perform vertical flight. The vertical propulsor is further disclosed below. Forward flight mode, as used in this disclosure, refers to a mode of an aircraft to propel an aircraft in a horizontal direction, such as but not limited to “airplane” mode. Forward propulsor may be used to perform forward flight. Additionally without limitation, the eVTOL aircraft disclosed herein maybe consistent with eVTOL aircraft disclosed in U.S. patent application Ser. No. 18/095,776, filed on Jan. 11, 2023, and entitled “A SYSTEM OF AN ELECTRIC AIRCRAFT WITH PITCH CONTROL USING AN ELEVATOR,” the entirety of which is incorporated by reference herein in its entirety.

With continued reference to FIG. 10, in some embodiments, aircraft 1000 may include an energy absorbing material. The energy absorbing material may be consistent with any energy absorbing material disclosed above. In an embodiment, the energy absorbing material may be configured to reduce occupant loading to between 5 and 50 F's during a 18 ft/sec test. As used in this disclosure, a “18 ft/sec test” is a type of test to test the safety of an aircraft while the aircraft decelerates at 18 ft/sec and crashes on a hard structure. As used in this disclosure, an “occupant loading” is amount of force that an occupant of an aircraft gets from a crash. As used in this disclosure, an “occupant” is any person who is in an aircraft. As a non-limiting example, the occupant may include a passenger, a pilot, and the like. In another embodiment, the energy absorbing material may be configured to reduce occupant loading to between 5 and 50 G's during a 26 ft/sec test. The 26 ft/sec test may be consistent with a 26 ft/sec aircraft drop test disclosed above. As a non-limiting example, the hard structure may include concrete, steel, and the like. In some embodiments, the energy absorbing material may be configured to reduce the occupant loading to between 5 and 50 G's during a 50 ft aircraft drop test. As used in this disclosure, a “50 ft drop test” is a type of test to test the safety of an aircraft while the aircraft decelerates at 56.7 ft/sec and crashes on the hard structure.

With continued reference to FIG. 10, in some embodiments, aircraft 1000 may include fuselage 1004. In some embodiments, fuselage 1004 may be consistent with a fuselage disclosed with respect to FIG. 3. In some embodiments, fuselage 1004 may include acrush zone. As used in this disclosure, a “crush zone” is area of an aircraft that is configured to get crushed when the aircraft crashes into the hard structure. In some embodiments, the crush zone may include an energy absorbing material. In some embodiments, the energy absorbing material may include frame crash panel 1008. In some embodiments, the crush zone may be located beneath aircraft 1000. In an embodiment, the crush zone may be located inside fuselage 1004. In another embodiment, the crush zone may be located outside fuselage 1004. In an embodiment, frame crash panel 1008 may be located in the crush zone, wherein the crush zone is located beneath aircraft 1000 and the inside of fuselage 1004. In another embodiment, frame crash panel 1008 may be located in the crush zone, wherein the crush zone is located beneath aircraft 1000 and outside of fuselage 1004 as shown in FIG. 10. frame crash panel 1008 may be consistent with a frame crash panel described above. In some cases, frame crash panel 1008 may include a material having a number of voids, for instance frame crash panel 1008 may take a form of a honeycomb, sinusoid, semi-circle or another predictably cellular form. In some embodiments, frame crash panel 1008 may include fiber composites, foams, gels, magneto-rheological (MR) fluids, metals, porous materials, and the like. As a non-limiting example, frame crash panel 1008 may include a honeycomb sandwich panel. The honeycomb sandwich panel disclosed herein is further described above. As another non-limiting example, frame crash panel 1008 may include a polymethacrylimide foam. The polymethacrylimide foam disclosed herein is further described above. Additionally, and without limitation, frame crash panel 1008 may be consistent with any energy absorbing material disclosed above.

With continued reference to FIG. 10, in some embodiments, the energy absorbing material is configured to absorb energy from the crash of aircraft 1000. In some embodiments, the crush zone may include a plurality of energy absorbing materials. As a non-limiting example, aircraft 1000 may include 5 frame crash panels 1008. As another non-limiting example, aircraft 1000 may include 10 frame crash panels 1008. In some embodiments, aircraft 1000 may include any number of frame crash panels 1008. In an embodiment, the plurality of frame crash panels 1008 may include the same type of the plurality of energy absorbing materials. As a non-limiting example, aircraft 1000 may include 6 frame crash panels 1008 that are made of honeycomb sandwich panel. In some embodiments, the plurality of frame crash panels 1008 may include different types of the plurality of energy absorbing materials. As a non-limiting example, aircraft 1000 may include 6 frame crash panels 1008, while 3 frame crash panels 1008 are made of honeycomb sandwich panel and 3 frame crash panels 1008 are made of polymethacrylimide foam. In an embodiment, frame crash panel 1008 may include different size. As a non-limiting example, frame crash panel 1008 may be the size of a whole bottom of fuselage 1004. As another non-limiting example, frame crash panel 1008 may be a half of the size of a whole bottom of fuselage 1004. As another non-limiting example, frame crash panel 1008 may be ⅛ of the size of a whole bottom of fuselage 1004. In some embodiments, frame crash panel 1008 may include any size.

With continued reference to FIG. 10, in some embodiments, an energy absorbing material may include a seat energy absorber. As used in this disclosure, a “seat energy absorber” is a type of anergy absorbing material that is placed on a seat and absorbs energy from a crash of an aircraft. As used in this disclosure, a “seat” is a seat on an aircraft in which an occupant is accommodated for the duration of a flight. In an embodiment, the seat energy absorber is configured to absorb energy during a 18 ft/sec test. In another embodiment, the seat energy absorber is configured to absorb energy during a 26 ft/sec test. In some embodiments, the seat energy absorber is configured to absorb energy during a 50 ft drop test. In some embodiments, the seat energy absorber may absorb 30 G. In another embodiment, the seat energy absorber may absorb less than 30 G. As a non-limiting example, the seat energy absorber may absorb 5 G, 10 G, 18 G, 22 G, 28 G, and the like. In another embodiment, the seat energy absorber may absorb more than 30 G. As a non-limiting example, the seat energy absorber may absorb 35 G, 40 G, 48 G, and the like.

With continued reference to FIG. 10, in some embodiments, an energy absorbing material may include landing gear 1012. As used in this disclosure, a “landing gear” is a gear that is used when an aircraft lands on a hard surface. In an embodiment, landing gear 1012 may be attached to aircraft 1000. As a non-limiting example, landing gear 1012 may be attached to fuselage 1004. In an embodiment, landing gear 1000 may function as a component of an undercarriage of an aircraft that supports the weight of aircraft 1000 when it is not in the air. In some embodiments, landing gear 1000 may be composed of any material suitable for composition of aircraft 1000, including without limitation wood, fabric, aluminum, steel, titanium, polymers, carbon fiber, graphite-epoxy, epoxy fiber glass, fiber glass, metal alloys, epoxy resin, resin, composites, and the like. Additionally without limitation, landing gear 1012 disclosed herein is consistent with a landing gear found in U.S. patent application Ser. No. 17/515,442, filed on Oct. 30, 2021, and entitled “LANDING GEAR ASSEMBLY FOR REDUCING DRAG ON AN AIRCRAFT,” and in U.S. patent application Ser. No. 17/196,719, filed on Mar. 9, 2021, and entitled “SYSTEM FOR ROLLING LANDING REAR,” the entirety of which are incorporated by reference herein in its entirety.

With continued reference to FIG. 10, in an embodiment, landing gear 1012 may be designed with a consideration of energy absorption during a landing. In another embodiment, landing gear 1012 may be designed with a consideration of energy absorption during a crash. In some embodiments, landing gear 1012 may be configured to reduce occupant loading during a 50 ft aircraft drop test. In some embodiments, landing gear 1012 may be configured to reduce occupant loading during a 18 ft/sec test. In some embodiments, landing gear 1012 may be configured to reduce the occupant loading during a 26 ft/sec aircraft drop test. In some embodiments, landing gear 1012 may be configured to reduce the occupant loading during a 50 ft drop test. In embodiments, landing gear 1012 may reduce the occupant loading by a half. As a non-limiting example, if a total occupant loading is 700 G, landing gear 1012 may reduce the occupant loading to 350 G. In another embodiment, landing gear 1012 may reduce the occupant loading by more than a half. As a non-limiting example, if a total occupant loading is 900 G, landing gear 1012 may reduce the occupant loading to 350 G. In some embodiments, landing gear 1012 may reduce the occupant loading by less than a half. As a non-limiting example, if a total occupant loading is 700 G, landing gear 1012 may reduce the occupant loading to 450 G.

Practice of the present invention may be aided by use of parameter ranges and characteristics described within Table 1.

| | Minimum | Maximum | Nominal |
|---|---|---|---|
| Battery Potential | 12 | 2000 | 500 |
| (Volts) | | | |
| Battery Controller | 0.5 | 25 | 5 |
| Potential (Volts) | | | |
| Battery Breakaway | 2 | 100 | 20 |
| Deceleration (G's) | | | |

| | |
|---|---|
| Case Materials | Aluminum alloy, steel, stainless steel, |
| | titanium, magnesium, brass, bronze, copper, |
| | beryllium, molybdenum, and the like. |
| Inner Panel Materials | Fiberglass, carbon fiber, thermoplastic |
| | composites, thermoset composites, and the like. |
| Liner Materials | Polyethylene (PE), polytetrafluorethylene |
| | (PTFE), and the like |
| Gasket Materials | Silicone, Fluorosilicone, Buna-N, and the like |
| Welding Processes | Laser welding, electric resistance welding, |
| | gas tungsten arc welding (GTAW), metal inert |
| | gas welding, friction stir welding, spot |
| | welding, electron beam welding, and the like. |
| Sheet-metal forming | Bending, stamping, pressing, and the like. |
| processes | |
| Machining processes | Milling, drilling, turning, electrical |
| | discharge machining, and the like. |
| Force required to | 219,865 (deceleration from 26 ft/sec in 4 inch) |
| decelerate in aircraft | |
| crash 26 ft/sec (lb) | |
| G load in Battery Pack | 4 |
| Area (G) | |

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments according to this disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system of energy absorption of an electric vertical take-off and landing (eVTOL) aircraft in a crash, the system comprising:
a battery pack of an electric aircraft, wherein the battery pack comprises:
a case, wherein the case is configured to circumscribe an inner volume of the battery pack; and
at least a battery module installed within the inner volume of the case; and
at least an energy absorbing material located beneath the electric aircraft,
wherein the at least an energy absorbing material comprises a first energy absorbing material and is configured to absorb energy from a crash of the electric aircraft.

2. The system of claim 1, wherein the case further comprises:
a sealing rim positioned at least partially about an open side of the case;
a first component that comprises at least a first side and a second side of the case; and
a second component that comprises at least a third side of the case, wherein the second component additionally comprises:
at least an electrical connection; and
at least a mechanical connection.

3. The system of claim 2, wherein the mechanical connection comprises a breakaway mount configured to release the battery module under a predetermined load.

4. The system of claim 1, wherein the first energy absorbing material is further configured to provide a deformable floor structure in the crash.

5. The system of claim 1, wherein the battery pack is configured to tolerate 50 ft battery drop test.

6. The system of claim 4, wherein the first energy absorbing material is completely crushable.

7. The system of claim 1, wherein the system is configured to reduce an occupant loading to between 5 and 50 G's during a 50 ft aircraft drop test.

8. The system of claim 1, wherein the first energy absorbing material comprises a panel, wherein the panel comprises a honeycomb sandwich panel.

9. The system of claim 8, further comprising:
a frame crash panel, wherein the frame crash panel is placed on a frame of the aircraft; and
a battery crash panel, wherein the battery crash panel is placed on the battery pack.

10. The system of claim 9, wherein:
the frame crash panel is configured to receive a first impact of the crash; and
the battery crash panel is configured to receive a second impact of the crash.

11. The system of claim 1, wherein the first energy absorbing material reduces an occupant loading during a 50 ft crash test to within a range of 5 to 50 G's.

12. The system of claim 1, further comprising:
a landing gear, wherein the landing gear is configured to reduce an occupant loading during a 50 ft aircraft drop test.

13. The system of claim 1, further comprising:
a seat energy absorber, wherein the seat energy absorber is located in a seat of the electric aircraft and is configured to absorb greater than 5 G in the crash of the electric aircraft.

14. The system of claim 1, wherein the inner volume of the case comprises a crush zone that does not contain the at least a battery module.

15. The system of claim 14, wherein the at least an energy absorbing material comprises a crush zone that comprises:
a frangible connection configured to provide electrical conduction between a plurality of the at least a battery module; and
a die configured to contact and separate the frangible connection when the battery pack is impacted with a sufficiently great connection breaking force.

16. The system of claim 15, wherein the die is further configured to break and electrically isolate the frangible connection.

17. The system of claim 15, wherein the die comprises a non-conductive material.

18. The system of claim 15, wherein the frangible connection comprises an electrical material having a yield strength of no greater than 5 MPa.

19. The system of claim 18, wherein the frangible connection further comprises aluminum.

20. The system of claim 1, further comprising:
an inner panel installed within the inner volume, between the case and the at least a battery module.
